(19) United States
(12) Patent Application Publication
(10) Pub. No.: US 2012/0118800 A1
(43) Pub. Date: May 17, 2012

(54) FILTER DEVICE

(76) Inventors: Viktor Josef Lauer, Nalbach (DE); Martin Freidinger, Saarbrucken (DE); Yves Muller, Gaubiving (FR)

(21) Appl. No.: 13/261,136

(22) PCT Filed: Jun. 23, 2010
(86) PCT No.: PCT/EP10/03836

§ 371 Date: Jan. 31, 2012

(30) Foreign Application Priority Data
Jul. 10, 2009 (DE) 10 2009 032 572.7

(51) Int. Cl. B01D 21/30

(52) U.S. Cl. 210/136; 210/348

(57) ABSTRACT

A filter device for filtering oil leakage amounts from hydraulic systems, wherein hydraulic oil can be sucked from a tank (4) via a suction line (10) and leakage oil can be fed via a leakage oil line (12) to the non-filtered side of a leakage oil filter (16). Filtered leakage oil can be fed back from the filtered side (20) of the filter to the tank (4). The invention is characterized in that a valve assembly (26) is provided, by way of which a fluid connection (22, 30) can be released between the filtered side (20) of the leakage oil filter (16) and the suction line (10) in order to reduce the leakage oil pressure in the leakage oil line (12).

The invention relates to a filter device for filtering leakage oil quantities from hydraulic systems, wherein the hydraulic oil can be drawn in from a tank by way of a suction line and leakage oil can be supplied by way of a leakage oil line to the dirty side of a leakage oil filter, and filtered leakage oil can be fed back from the clean side of the filter to the tank.

Such filter devices conforming to the prior art enable the return of the leakage oil quantities, which accumulate under normal operating conditions, into the system circuit without running the risk of dragging the impurities, be they abrasion particles or dirt particles entrained from the lines, into the tank and, thus, into the system. The leakage oil quantities that accumulate under normal operating conditions can fluctuate over a relatively wide range as a function of the operating conditions of the system or can exhibit a varying volumetric rate of flow, depending on the system component from which the leakage oil issues. Therefore, the overall results for the respective leakage oil filter are operating conditions that fluctuate over a relatively wide range.

On the basis of this problem, the object of the invention is to provide a filter device that is intended for filtering leakage oil quantities and that is characterized by good operational performance behavior, in particular even in the event of varying quantities of leakage oil accumulation.

This object is achieved according to the invention by a filter device having the features specified in claim 1 in its entirety.

An important aspect of the invention resides in the fact that there is a valve assembly, by way of which a fluid connection between the clean side of the leakage oil filter and the suction line can be released. This strategy offers the advantageous possibility of reducing, as required, the leakage oil pressure by applying the suction pressure prevailing in the suction line to the clean side of the leakage oil filter. This approach makes it possible to counteract in an effective way a higher differential pressure building up at the leakage oil filter when the quantities of leakage. oil increase as a function of the operating mode, so that a preferably low pressure can be maintained in the leakage oil line even in the case of fluctuating quantities of leakage oil. If, for example, a variable displacement pump is mounted in the suction line, then the quantity of leakage oil that issues will be higher when the pump is set to a high rate of delivery, a feature that results in a greater drop in pressure at the leakage oil filter and, hence, is equivalent to a higher pressure of the leakage oil line. At the same time, the high rate of delivery leads to a correspondingly higher suction pressure of the suction line, and this higher suction pressure can become active on the clean side of the leakage oil filter by way of the valve assembly. Therefore, it is possible for the leakage oil pressure to reach a kind of equilibrium state in the leakage oil line.

In especially advantageous embodiments, the valve assembly has a pilot operated 2/2-way directional control valve, especially in the form of a proportional valve.

The valve assembly can be configured in such an especially advantageous way that the control piston of the directional valve that is formed by a spool valve is mechanically preloaded into the position blocking the throughflow between its input connection and its output connection and that the leakage oil pressure is active at the control piston against its mechanical preload by way of a control connection that is connected to the leakage oil line. This makes it possible to set, as a function of the amount of the preload, a threshold value for the leakage oil pressure that causes the valve assembly to respond.

In especially advantageous embodiments, the suction pressure of the suction line is also active at the control piston against its mechanical preload by way of a second control connection that is connected to the suction line. This counteracts both the suction pressure of the suction line, where said suction pressure increases, for example, as the rate of delivery of an associated variable displacement pump increases, and also the leakage oil pressure of the mechanical preload of the directional valve and supports the opening behavior of the directional valve in order to counteract an increase in the leakage oil quantity, which corresponds to the higher rate of delivery, and/or the resulting leakage oil pressure.

In especially advantageous embodiments, the valve assembly is integrated into the head part of a filter housing that accommodates at least one filter element of the leakage oil filter. This allows the entire filter device together with the device controlling the pressure of the leakage oil line to form a compact component, which can be incorporated into hydraulic systems even under confined space conditions.

At the same time, the valve assembly can be configured in such a way that the head part has inner fluid guides for fluid paths to the connections of the valve assembly and to the outer connections for the leakage oil line, the suction line, and to the tank line connecting the clean side of the leakage oil filter to the tank. This eliminates the need for the component to have external connecting lines for the device controlling the leakage oil pressure.

For this purpose, the valve assembly can be configured in such an advantageous way that the head part has a drill hole that is constructed as the valve housing of the control piston of the directional valve so that the control piston can be displaced therein; and that a fluid guide runs from the connection of the suction line to the output connection at the drill hole of the valve housing.

In embodiments in which the respective filter element in operation is traversed by flow from the outside of the element to an inner filter cavity, the valve assembly is configured preferably in such a way that the connection of the leakage oil line empties at the head part into a fluid guide, which runs in the filter housing to the outside of the at least one filter element that forms the dirty side as well as to a control connection of the directional valve, said connection being located on the end of the drill hole of the valve housing.

An especially compact design for a filter element, which is traversed by flow from the outside to the inside, is produced when the head part exhibits a fluid guide that runs from the inner filter cavity of the filter element, said cavity forming the clean side, to the input connection at the drill hole of the valve housing as well as to the connection for the tank line.

In order to guarantee that the filter device is protected in the conventional manner against impurities blocking the filter element, the head part has a fluid guide that can be shut off from the dirty side of the filter housing to the fluid guide adjacent to the clean side of the filter element by means of a bypass valve, which can be released by a pressure of the dirty side that exceeds a threshold value.

The invention is explained in detail below by means of an exemplary embodiment that is depicted in the drawings.

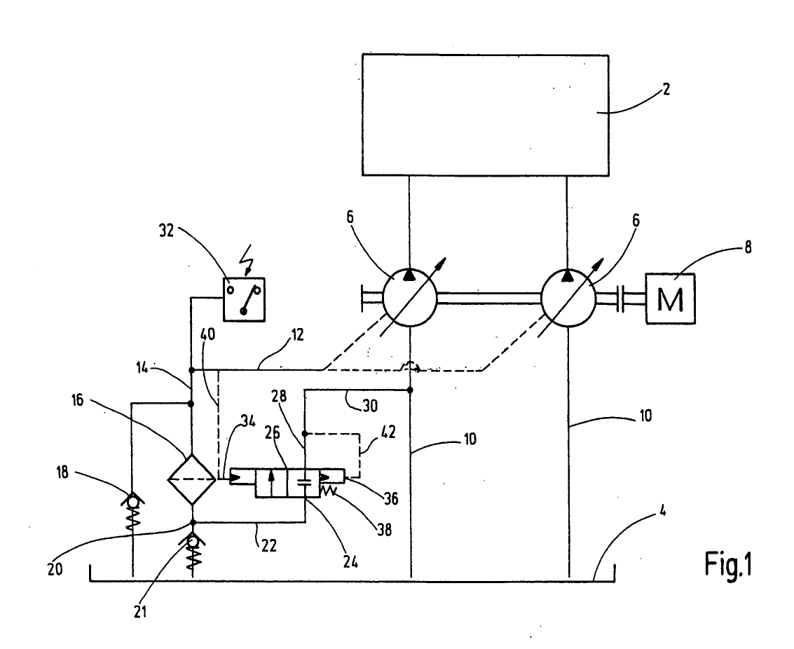

FIG. 1 shows a simplified schematic block diagram of just a subsection of a hydraulic system, which is pressurized by two hydraulic pumps in the form of variable displacement pumps, wherein the generated leakage oil quantities can be recycled by means of an exemplary embodiment of the filter device according to the invention,

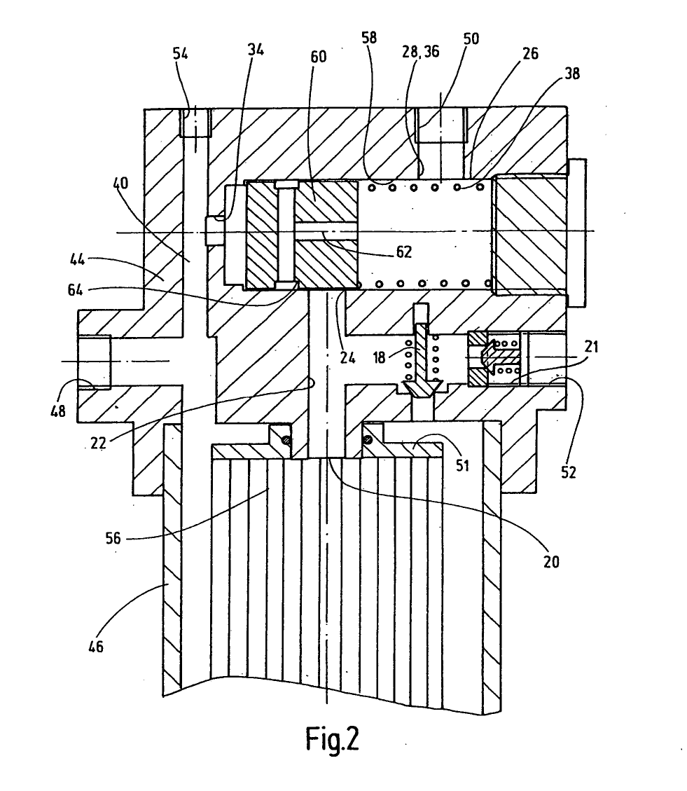

FIG. 2 shows a simplified schematic drawing of a broken out section of an exemplary embodiment of the filter device according to the invention, and

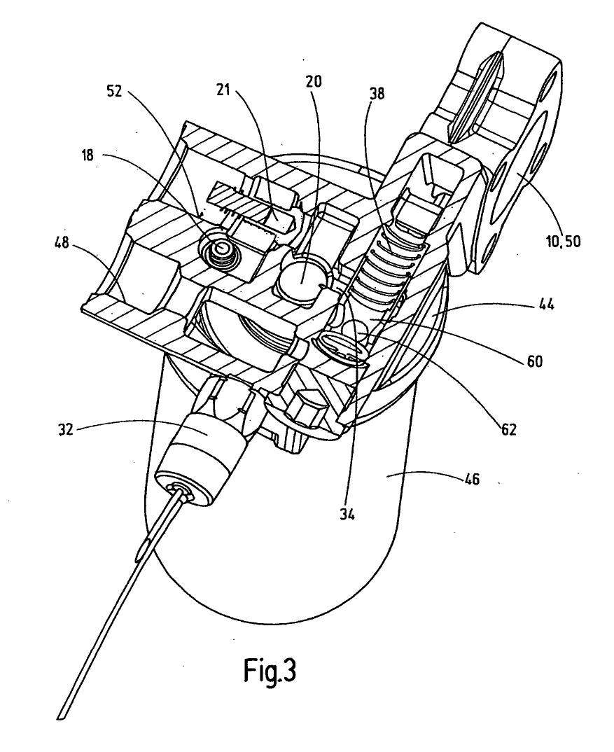

FIG. 3 shows a perspective oblique view of a practical design of the exemplary embodiment with the head part of the leakage oil filter cut open.

The invention is explained below by means of an example, wherein the filter device is assigned to a hydraulic system comprising a drive and control unit 2 that is depicted in FIG. 1 as a block diagram and that is supplied with hydraulic oil from a tank 4 by means of variable displacement pumps 6, which are driven jointly by a motor 8. The suction lines between the suction side of the pumps 6 and the tank 4 are designated with the reference numeral 10. The leakage oil of the pumps 6 flows over a common leakage oil line 12 to the leakage oil connection 14 on the dirty side of the leakage oil filter 16. A bypass valve 18, which is inserted between the leakage oil connection 14 and the tank 4, opens in a pressure actuated manner in the conventional way when the dynamic pressure exceeds a threshold value at the leakage oil filter 16—in the present example, when the dynamic pressure is 0.8 bar.

The clean side 20 of the filter 16 is connected to the tank 4 by means of a check valve 21, which opens at a low pressure level—at 0.05 bar in the present example. In addition, the clean side 20 is connected by means of a fluid path 22 to the input connection 24 of a 2/2-way proportional valve 26 comprising an output connection 28 that is connected to the suction line 10 by means of a fluid path 30. A clogging indicator, which is connected to a leakage oil connection 14 of the filter 16 and is designated as 32, generates an electrical indicator signal for a pressure prevailing on the dirty side. In the present example, where the bypass valve 18 is adjusted to 0.8 bar, the clogging indicator 32 is set, for example, to an indication value of 0.7 bar.

The directional valve 26 in the form of a spool valve is preloaded by mechanical means into its closing position (shown in the drawing), from which it can be moved by hydraulic means into a passage position by way of a first control connection 34 and a second control connection 36. In the present example, the preloading, which is exerted on the control piston of the valve 26 by means of a compression spring 38, corresponds to a hydraulic pressure differential of 0.5 bar established at the control piston. The first control connection 34 is connected to the leakage oil connection 14 by way of a control line 40. The second control connection 36 is connected to the fluid path 30 by way of a control line 42 and, thus, supplies the suction pressure prevailing in the suction line 10.

If, under normal operating conditions, the variable displacement pumps 6 are set to a low rate of delivery or zero delivery, so that the leakage oil quantity draining through the leakage oil line 12 is small, and correspondingly the functional filter element of the leakage oil filter 16 does not experience a significant drop in pressure, so that the leakage oil pressure in the leakage oil line 12 is low and, as a result, no opening pressure is applied at the first control connection 34 by way of the control line 40, the directional valve 26 remains in the closing position owing to its mechanical preload. Since there is virtually no suction pressure in the suction line 10 when the rate of delivery of the variable displacement pumps 6 is low or absent, no pressure that could counteract the preload of the control piston is active at the second control connection 36 of the directional valve 26 by way of the fluid path 30 and the second control line 42. If the directional valve 26 is closed, then the filtered leakage oil quantity flows off to the tank 4 by way of the check valve 21, which is adjusted to the low opening pressure.

If, on the other hand, the variable displacement pumps 6 are set to a high rate of delivery so that a larger quantity of leakage oil flows to the filter 16 by way of the leakage oil line 12, and a corresponding dynamic pressure builds up at the filter 16, then the first control connection 34 of the directional valve 26 has a corresponding opening pressure. Since at the same time that the rate of delivery of the variable displacement pumps 6 increases, the suction line 10 experiences a corresponding increase in the suction pressure that is active for the purpose of opening at the second control connection 36 of the valve 26 by way of the fluid path 30 and the second control line 42, preloading of the valve 26 counteracts not only the leakage oil pressure, but also the suction pressure of the suction line 10, so that when preloading of the valve 26 is 0.5 bar as stated in the example, the valve 26 opens at a leakage oil pressure of less than 0.5 bar. Expressed in more precise terms, given the said example, where the suction pressure is, for example, 0.2 bar in the suction line 10, a leakage oil pressure of 0.5 minus 0.2 bar—that is, 0.3 bar—would suffice to open the valve 26. As soon as this occurs, the suction line 10 is connected to the clean side 20 of the filter 16 by way of the fluid paths 30 and 22, so that the suction pressure of the suction line 10 is active at the filter 16 and causes a drop in the leakage oil pressure, which flows then in a filtered state via the fluid paths 22 and 30 to the suction line 10. In this case, the check valve 21 is closed subject to the action of the suction pressure.

Therefore, it is clear that in the present example in the no load mode, where no suction pressure is active in the suction line 10, the leakage oil pressure in the leakage oil line 12 is limited to the value of 0.5 bar, which is equivalent to the mechanical preload. In operating states under load with increasing leakage oil quantities and correspondingly increasing leakage oil pressure, both the leakage oil pressure for the purpose of opening is active at the first control connection 34 of the valve 26, and the correspondingly increasing suction pressure of the suction line 10 is active for the purpose of opening at the second control connection 36 of the valve 26. This means that the opening characteristic of the valve assembly is adapted to the operating parameters. Therefore, especially in the case of a directional valve 26 in the form of a proportional valve, it is possible for the leakage oil pressure to achieve a state of equilibrium.

FIGS. 2 and 3 illustrate the installation of the filter device into the head part 44 of the housing 46 of the leakage oil filter 16. As shown the best in FIG. 2, the head part 44 has an outer connection 48 for the leakage oil line 12, an outer connection 50 for the suction line 10, a tank connection 52, and a connection 54 for the clogging indicator 32. Inflowing leakage oil flows through the connection 48 to the outside, that is, to the dirty side, of the filter element 56, which is traversed by flow from the outside inward to the clean side 20, which is located in the inner filter cavity. The filter element 56 is mounted on a receptacle of the head part 44 with its upper end cap 51, which is visible in FIG. 2, so that the cleaned leakage oil flows from the clean side 20 into the fluid path 22, which leads to the input connection 24 of the directional valve 26. In addition, a connection to the tank connection 52 branches off from the fluid path 22, which is connected to the clean side 20, with the check valve 21 being mounted upstream of the tank connection 52. The bypass valve 18 enables a direct connection between the outside (dirty side) of the filter element 56 and the line branch to the tank connection 52.

The fluid path between the leakage oil connection 48 and the connection 54 for the clogging indicator forms the control line 40, which runs to the first control connection 34 of the directional valve 26. This control connection 34 is preferably located on an axial end of the drill hole 58, which forms the valve housing of the directional valve 26, in which the control piston 60 can be moved axially. The piston 60 abuts, over an equal area, the pressure chamber with the first control connection 34 and abuts the opposing pressure chamber, where the second control connection 36, which simultaneously forms the suction line connection 50, is located. The pressure spring 38, located in this pressure chamber, preloads the piston 60 into the closing position shown on the left in FIG. 2. If the piston 60 is moved to the right in FIG. 2 against the spring force by means of the leakage oil pressure at the control connection 34 and the supporting suction pressure at the second control connection 36, then the channels 62, which empty into the control edges 64, in the piston 60 form the fluid connection from the input connection 24 to the pressure chamber, which is connected to the suction line connection 50, in the drill hole 58.

FIG. 3 illustrates a practical design with the valve assembly integrated into the head part 44 of the filter housing 46, wherein the components with the same reference numerals are marked in accordance with FIGS. 1 and 2. It is clear from the figure that the valve assembly with the associated housing 46 of the leakage oil filter is assembled so as to form a compact component.

1. A filter device for filtering leakage oil quantities from hydraulic systems, wherein the hydraulic oil can be drawn in from a tank (4) by way of a suction line (10), and leakage oil can be supplied by way of a leakage oil line (12) to the dirty side of a leakage oil filter (16), and filtered leakage oil can be fed back from the clean side (20) of the filter to the tank (4), characterized in that there is a valve assembly (26), by way of which a fluid connection (22, 30) between the clean side (20) of the leakage oil filter (16) and the suction line (10) can be released in order to reduce the leakage oil pressure in the leakage oil line (12).

2. The filter device according to claim 1, characterized in that the valve assembly has a pilot operated 2/2-way directional control valve (26), in particular a proportional valve.

3. The filter device according to claim 2, characterized in that the control piston (60) of the directional valve (26), formed by a spool valve, is mechanically preloaded into the position blocking the throughflow between its input connection (24) and its output connection (28), and that the leakage oil pressure is active at the control piston against its mechanical preload (38) by way of a control connection (34) that is connected to the leakage oil line (12).

4. The filter device according to claim 3, characterized in that the suction pressure of the suction line (10) is active at the control piston (60) against its mechanical preload (38) by way of a second control connection (36) that is connected to the suction line (10).

5. The filter device according to claim 1, characterized in that the valve assembly (26) is integrated into the head part (44) of a filter housing (46) that accommodates at least one filter element (56) of the leakage oil filter (16).

6. The filter device according to claim 5, characterized in that the head part (44) has inner fluid guides (22, 40) for fluid paths to the connections (34) of the valve assembly (26) and to the outer connections (48, 50) for the leakage oil line (12), the suction line (10), and to the tank line connecting the clean side (20) of the leakage oil filter (16) to the tank (4).

7. The filter device according to claim 6, characterized in that the head part (44) has a drill hole (58) that is configured as the valve housing of the control piston (60) of the directional valve (26) so that the control piston can be displaced therein; and that a fluid guide (30) runs from the connection (50) of the suction line (10) to the output connection (36) at the drill hole (58) of the valve housing.

8. The filter device according to claim 7, characterized in that the connection (48) of the leakage oil line (12) discharges at the head part (44) into a fluid guide (40), which runs in the filter housing (46) to the outside of the at least one filter element (56) that forms the dirty side as well as to a control connection (34) of the directional valve (26), said connection being located on the end of the drill hole (58) of the valve housing.

9. The filter device according to claim 6, characterized in that the head part (44) has a fluid guide (22) that runs from the inner filter cavity of a filter element (56), said cavity forming the clean side (20), to the input connection (24) at the drill hole (58) of the valve housing as well as to the connection (52) for the tank line.

10. The filter device according to claim 8, characterized in that the head part (44) has a fluid guide that runs from the dirty side of the filter housing (46) to the fluid guide (22) abutting the clean side (20) of the filter element (56) and can be shut off by a bypass valve (18) that can be released by a pressure of the dirty side that exceeds a threshold value.
